(19) United States
(12) Patent Application Publication
(10) Pub. No.: US 2005/0129020 A1
(43) Pub. Date: Jun. 16, 2005

(54) Method and system for providing data communications over a multi-link channel

(76) Inventors: Stephen Doyle, Ennis (IE); Muthaiah Venkatachalam, Hillsboro, OR (US)

Correspondence Address: KENYON & KENYON, 1500 K STREET, N.W., SUITE 700, WASHINGTON, DC, 20005, US

(21) Appl. No.: 10/732,211

(22) Filed: Dec. 11, 2003

(51) Int. Cl. H04L 12/28

(52) U.S. Cl. 370/392; 370/474

(57) ABSTRACT

Embodiments of the present invention provide a method and system for multi-link data communications using a multi-threaded and/or multi-processor system. An embodiment of the present invention includes a receive interface to couple to a multi-link communications channel. A processing system processes header portions of data fragments received from the multi-link communications channel. A separate processing system processes payload portions of the data fragments from the multi-link communications channel. The payload processing system includes a memory that is slower than a memory of the header processing system.

### BACKGROUND OF THE INVENTION

The present invention relates to data communications. In particular, embodiments of the present invention provide a method and system for multi-link data communications.

Many protocols are available for data communications over wired and/or wireless media. In accordance with some protocols, data packets and/or data frames may be transmitted over a variety of interface media and may be re-assembled at a destination. Researchers and/or design engineers are continuously developing new techniques for faster, more accurate, and more efficient data communications.

One such protocol, known as the Point-to-Point Protocol (PPP) provides a method for connecting a computer to the Internet and also provides error-checking features. Using PPP, data packets are sent to a server that transmits them over the Internet or other communications network media. A destination server or computer may receive the data packets where the data packets may be re-assembled and provided as useful information to a host computer, for example.

The Internet Engineering Task Force (IETF) publishes many documents that describe a variety of communications protocols.

For example, RFC1990 (Request for Comments) describes a multi-link protocol extension (PPP-ML) to the basic PPP protocol. It describes a method for splitting, recombining and sequencing datagrams across multiple logical data links. Sklower, K., et. al, RFC1990 The PPP Multi-Link Protocol, August 1996.

Another document known as RFC2686 proposes extensions to the multi-link protocol by introducing the concept of classes to the protocol, referred to as PPP-ML/MC. Bormann, C., RFC2686 The Multi-Class Extension to the Multi-Link PPP, September 1999. These classes can be used to help achieve quality of service differentiation on the link by not letting the low priority traffic block the transmission of higher priority traffic for extended periods of time.

An improvement to the PPP-ML/MC technique is described in RFC 3153. RFC3153 describes a method to reduce the PPP framing overhead used to transport small packets over slow links by sending multiple PPP encapsulated packets in a single PPP frame (referred to as the PPP-Mux). Pazhyannur, R., RFC 3153 PPP Multiplexing, August 2001.

While these specifications and others are useful to define data formats and protocols for data exchange on a multi-link channel, they appear to require transmitting and receiving agents (hereinafter “source devices” and “sink devices” respectively) to perform a number of high latency operations which can limit performance at the source and/or sink device. The acts of splitting, recombining, load balancing and sequencing datagrams or fragments from the individual links in the multi-link channel can require a source device to make multiple copies of the datagrams or fragments in its internal memory. Each copy operation in memory consumes instruction cycles and memory bandwidth and memory space. Also the source device may need to support several thousands of multi-link channels and several classes on each channel, which in turn may increase the instruction cycles and memory bandwidth and memory space by several orders of magnitude. Therefore, there is a need in the art for communication methods that generate standards-compliant implementation for multi-link data transmissions while at the same time reduce latencies and enhance performance that are inherent in those methods.

### BRIEF DESCRIPTION OF THE DRAWINGS

FIG. 1 is a block diagram of an ingress pipeline in accordance with an embodiment of the present invention.

FIG. 2 is flowchart illustrating an exemplary method in accordance with an exemplary embodiment of the present invention.

FIG. 3A provides a diagrammatic representation of the relationship between fragments and super-frames in accordance with an embodiment of the present invention.

FIG. 3B provides a diagrammatic representation of the relationship between frames and super-frames in accordance with an embodiment of the present invention.

FIG. 4 is a block diagram of an egress pipeline in accordance with an embodiment of the present invention.

FIG. 5 is flowchart illustrating an exemplary method in accordance with an exemplary embodiment of the present invention.

FIG. 6 is a block diagram illustrating an example of data processing in ingress and egress pipelines in accordance with embodiments of the present invention.

FIG. 7 is a diagrammatic representation of a sequence array in accordance with an embodiment of the present invention.

FIG. 8 is a diagrammatic representation of frame and fragment formats at the egress pipeline, in accordance with an embodiment of the present invention.

FIG. 9 is flowchart illustrating an exemplary method in accordance with an exemplary embodiment of the present invention.

### DETAILED DESCRIPTION

In an embodiment of the invention, a plurality of data packets or fragments may be received into an ingress pipeline of a network processor from the several member links of the multi-link channel. The received fragments may include “header” data as well as “payload” data. Header data is administrative or system overhead information that includes data to guide the message to its correct destination. Headers include data such as sender's and receiver's addresses, precedence level, routing instructions, synchronization pulses, etc. Payload data is typically the useful information in the message that is being transported from the sender to the receiver.

In accordance with embodiments of the present invention, headers may be stripped from the fragments. Meta-data, generated from information in the stripped headers and other information relating to the payload, may be stored in a lower latency memory such as a SRAM (static random access memory). The payload data may be moved to a higher latency memory such as a DRAM (dynamic random access memory). SRAMs offer faster access times over other memories such as DRAMs, but because SRAMs can be expensive to produce, such memories are typically limited in size.

The meta-data in SRAM may be examined and used to generate super-frames and/or frames from the received fragments. The meta-data may maintain an association with the payload data in DRAM using data pointers. The data pointers may be used to access the payload data in DRAM, generate data fragments and/or data frames using the processed meta-data.

Embodiments of the present invention may minimize the number of high latency DRAM to DRAM copies of payload data that may be needed for processing, using conventional methods. Minimizing the number of copies needed for processing may minimize the number of accesses to high latency DRAM that can cause performance bottlenecks.

In embodiments of the invention, a sequencing array may be used to place the received fragments in the proper order for reassembly into appropriate frames and/or super-frames. Fragments that are in the proper order may be forwarded for processing into the appropriate frame as soon as the first fragment belonging to the frame is received. As additional in-order fragments for that particular frame are received, they may be forwarded for re-assembly to the associated frame, without delay. This may prevent unnecessary use of memory resources and/or may prevent processing delays. In embodiments of the invention, out of order fragments for that particular frame may be placed in the sequencing array. When the fragments in the sequencing array are in the proper order they may be removed from the sequencing array and forwarded for reassembly into the appropriate frame.

On the egress pipeline transmit side, frames for transmission may be enqueued into a Queue Manager based on the class and/or multi-link channel information in the meta-data associated with each fragment. Each multi-link (ML) channel may have transmission queues registered with the queue manager with the number of queues registered for the multi-link channel being equal to the number of multi-channel (MC) classes supported for the multi-link channel. A Scheduler may schedule fragment data as a set of fragments and may send dequeue requests to the queue manger for each fragment. The queue manager may forward the scheduled fragments to a PPP (Point-to-Point Protocol) Multiplexer (PPP mux). The multiplexer may pre-pend PPP mux header information to the fragment if the fragment is the start of a new PPP mux super-frame or if the fragment is the start of a new frame within a PPP mux super-frame. The multiplexer may forward the fragment to the ML/MC load balancer. The load balancer may assign a member link within the ML channel to the fragment. The transmit driver may pre-pend a ML/MC header and transmit the fragment over the assigned member link.

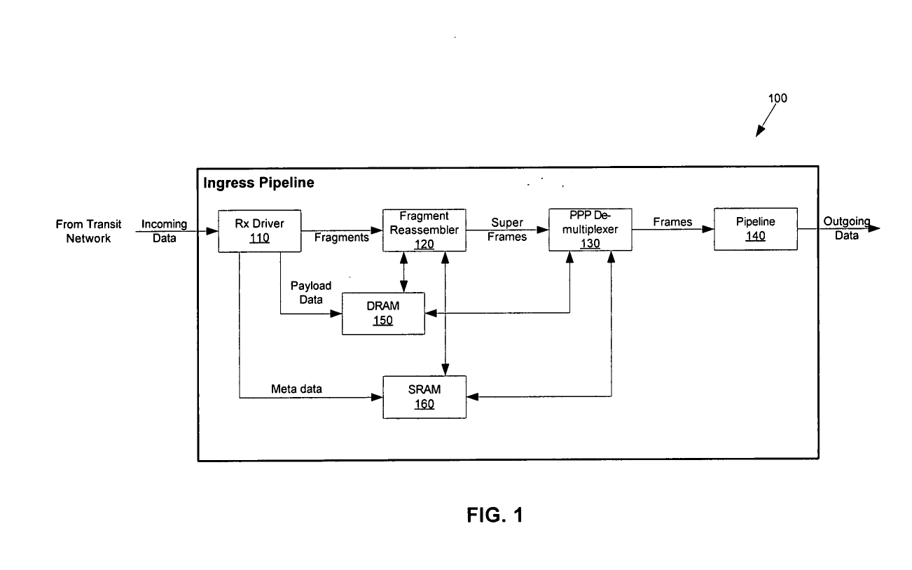

FIG. 1 is a functional block diagram showing a system including an ingress pipeline 100 at a destination device according to an embodiment of the present invention. The ingress pipeline 100 may include a receive driver (Rx driver 110) that receives incoming fragments from a transit network and may write payload data to memory 150 and meta-data to memory 160. In embodiments of the present invention memory 160 may be a low or lower latency memory such as a SRAM and memory 150 may be a higher latency memory such as a DRAM. Receive driver 110 may also be coupled to a fragment re-assembler 120 that may be further coupled to a de-multiplexer 130. The receive driver 110 may be coupled to, for example, a multi-link channel and may receive incoming data from another device in a transit network via the multi-link channel.

In an embodiment of the present invention, the fragment re-assembly block 120 may reassemble individual fragments received on the member links of the multi-link channel into super-frames and/or frames. The PPP de-multiplexer block 130 may extract the individual frames from the super-frame it may receive from the fragment reassembler 120 and output data to a processing pipeline represented by block 140. The re-assembly block 120 and the de-multiplexer block 130 may access the meta-data stored in SRAM 160 and the payload data stored in DRAM 150. The pipeline 140 may perform other processes on the frames such as IP (Internet Protocol) forwarding, Quality of Service processing, ATM (Asynchronous Transfer Mode) processing, etc.

The transit network may be a communications network that may include, for example, a public switched telephone network (PSTN), an Integrated Services Digital Network (ISDN), a cellular network, a digital mobile network, a Personal Communication Systems (PCS) network, an Internet, an intranet, a signaling system 7 (SS7) network, a local area network (LAN), a satellite network, an advance intelligent network (AIN), any suitable digital or analog network, a broadband network such as a cable network, any other suitable national and/or international communications network or any suitable combination thereof.

In embodiments of the present invention, the transit network may provide a connection to and/or may include additional computers, modules and/or devices that may be included in a local-area network (LAN), a wide-area network (WAN), a campus-area network (CAN), a metropolitan-area network (MAN), a home-area network, an Intranet, Internet and/or any other type of computer network.

In embodiments of the present invention, the transit network may include a plurality of switches, communication interfaces, and/or other components that are omitted. It is recognized that the communications that may be provided may include hard-line, wireless, RF (radio frequency), optical, or any other type of communications and/or any combination thereof. The various devices, systems, networks, etc. may be appropriately configured or equipped with hardware and/or software to operate in such environments.

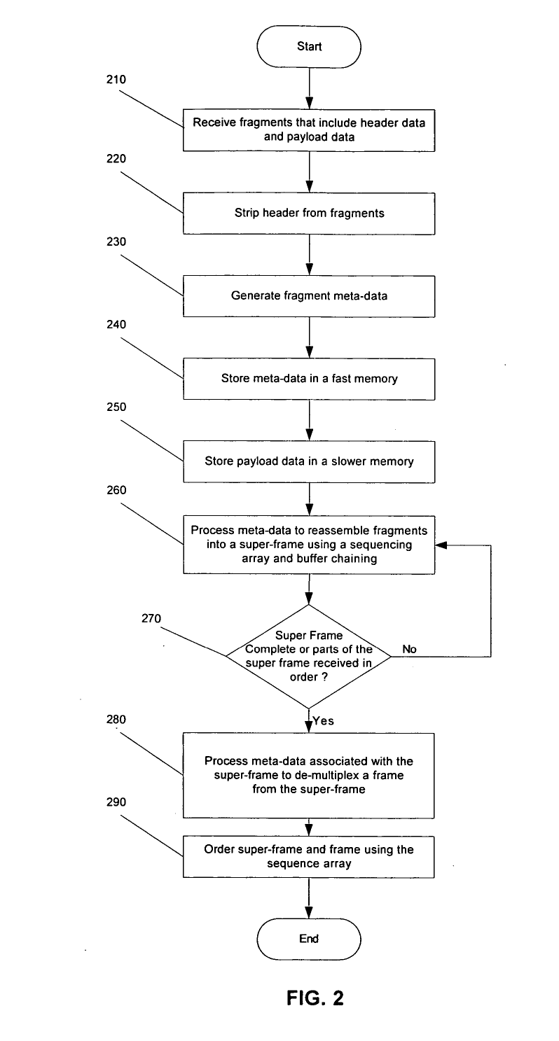

FIG. 2 is a flowchart illustrating a method in accordance with an embodiment of the present invention. As shown in FIG. 2, the Rx driver 110 may receive incoming data in the form of data fragments, as shown in box 210 of the flowchart. These data fragments may be received from a transit network via a media interface that may provide a connection to a transmission media or a multi-link channel. The transmission media may be represented as a single transmission multi-link channel that may include a plurality of individual member links. For example, the multi-link channel may be an Integrated Services Digital Network (ISDN) link where all of the channels may be used for carrying data fragments and/or frames. It is recognized that the media interface may be any type of media interface.

The received data fragments may include a header portion and a payload portion. The Rx driver 110 may strip the header from the fragments and generate meta-data based on the header data for the received fragments, as shown in boxes 220 and 230.

In embodiments of the present invention, the meta-data may include, for example, an identification of the member link in the multi-link channel, the correct multi-link channel itself upon which this frame was received, start of packet indicator, end of packet indicator, sequence number, class identifier, member link identifier, multi-link channel identifier, fragment length, frame length, pointer identifying the associated payload data in DRAM, and/or pointer to the meta-data of the next fragment in the chain. The Rx driver 110 may examine the header portion and based on, for example, the protocol field value, it may build the fragment meta-data.

Moreover, in embodiments of the present invention, the Rx driver 110 may strip the payload data included in the payload portion and store the meta-data in a faster memory, as shown in box 240. The payload data may be stored in a slower memory, as shown in box 250. In embodiments of the present invention, a position identifier such as a pointer to the payload data in memory 150 may be maintained in the meta-data to associate the meta-data with its corresponding payload data in memory 150.

In embodiments of the present invention, the meta-data generated based on the stripped header may include, for example, an identifier or pointers to a location in memory such as DRAM 150 where corresponding payload data may be stored as well as the fragment's position within a re-assembly frame, sequence number and/or other information. The fragment's position within a re-assembly frame may be determined from the “B” and “E” bits and the sequence number in the received fragment's header. For example, a fragment with the bit B (Begin) set indicates that it is the first fragment of the re-assembled frame while a fragment with the bit E (End) set indicates that it is the last fragment of the re-assembled frame. The sequence number may indicate the relative ordering of fragments. Each re-assembly for a super-frame may be given a super-frame sequence number known as the super-frame identifier (super-frame ID) by the re-assembler block 120. The super-frame ID may be used to order super-frames later during further processing.

In embodiments of the present invention, the fragments may be re-assembled into a super-frame using, for example, a sequence array and buffer chaining, as shown in box 260. This re-assembly may be accomplished without copying payload data from one area of the DRAM to another. For example, the meta-data from the memory 150 may be forwarded to a fragment re-assembly block 120. In an embodiment of the present invention, re-assembly block 120 may reassemble data associated with the individual fragments received over a set of links, which may be logically grouped to form a multi-link channel. Data received over this multi-link channel may belong to one or more classes. Each class within the multi-link channel may have a separate re-assembly context.

In embodiments of the present invention, the meta-data may include a class identifier (class ID) which may have been contained within the header of the received fragment. The class ID and other meta-data, including the member link in the multi-link channel that the fragment was received on, may identify the reassembly context for the fragment. Each re-assembly context may have its own sequence space and a sequence number of the received fragment may be used to order the received fragments within a particular context.

In embodiments of the present invention, processing may be optimized by determining whether fragments belong to a frame and if so, the fragments may be sent, in order, to de-multiplexer 130 for processing. These forwarded fragments may be forwarded in order and may skip the reassembly step. This optimization may avoid any unnecessary latencies that may result from reassembling the fragments into a complete frame prior to forwarding the complete frame to the de-multiplexing block 130. By examining the start of the re-assembled frame, which may correspond to the start of the first fragment within the frame, it may be possible to determine if that frame is a super-frame. A super-frame may include a plurality of frames that may help reduce framing overhead, in accordance with embodiments of the present invention.

Embodiments of the present invention may optimize the processing of super-frames by forwarding ordered fragments within a super-frame to the de-multiplexer block 130. The ordered fragments may be forwarded to the de-multiplexer block 130 as soon as the first fragment within its corresponding super-frame has been received at the fragment re-assembly block 120. Accordingly, in embodiments of the present invention, it may not be necessary to wait for missing fragments in earlier super-frames and so, data fragments can be processed as soon as they are received.

Received fragments may be re-assembled in the fragment re-assembly block 120. In this case, the frame re-assembly process may involve chaining together ordered fragments within a frame. This re-assembly process can begin as soon as the first fragment for a particular frame has been received. The sequencing array can be used to order the reassembled and/or partially reassembled frames. For example, a sequence number included in the fragments meta-data may be used to ensure correct ordering. Fully reassembled frames are forwarded from the re-assembly block 120. In this manner, storing a large number of fragments in a buffer while waiting for a fragment within a particular frame may not be needed.

In particular, in the case of a missing fragment for a particular frame, it is only necessary to store subsequent fragments for that frame. Fragments relating to other frames on a different class of the same multi-link channel and/or same/different class of a different multi-link channel may still be processed. Embodiments of the invention may be optimized so that fragments may be processed as soon as possible.

In embodiments of the present invention, fragment loss may be detected by tracking the sequence numbers received on each link within a multi-link channel. This process is further described in RFC1990. A variable M may be used to maintain the minimum sequence number that has been received on the links. If, for example, M exceeds the sequence identifier (sequence ID) of a missing fragment, then that fragment may be deemed lost. Accordingly, fragment loss on a member link may be detected based on the foregoing technique.

Fragment loss through link failure may be detected using knowledge of the link rates, and the difference in link rates. This information may be used to calculate the maximum number of fragments that can be “buffered” before a missing fragment is determined to be lost. This “buffer depth” may be the maximum allowable sequence skew. If a lost fragment has been detected, all other fragments within that frame may need to be discarded. For example, fragments that have already been processed either by the re-assembly block 120 or by the de-multiplexer block 130 may need to be discarded if a subsequent fragment in the frame or mux-frame is determined to be lost. In the de-multiplexer 130, data associated with a lost fragment may be discarded by, for example, sending an empty fragment with an error flag set and with the frame ID of the frame data to discard to the multiplexer block 130.

In embodiments of the present invention, the de-multiplexer may extract PPP frames from within a PPP super-frame. The start of a PPP super-frame identifies the frame as a PPP frame and this header may be stripped from the frame. Each frame contained within the super-frame begins with a header, in accordance with RFC 3153. This header includes a length field that is used to determine the length of the frame. The frame header may be stripped and the frame data may be extracted. This extraction process involves minimal DRAM to DRAM copies, only when a fragment contains a frame delimiter (in which case the fragment is split into 2 or more copies for the two or more frames embedded in the fragment and re-chained accordingly); otherwise it involves the generation of new meta-data that describes the extracted frame. Minimal number of DRAM to DRAM copies may reduce the access to DRAM and thereby reduce performance bottlenecks. This newly generated meta-data may be stored in SRAM. The above process may continue until all the frames have been extracted from the super-frame. Once all the frames have been extracted from the super-frame the meta-data associated with the super-frame may no longer be required and may be discarded.

To ensure ordering of the frames leaving the de-multiplexer, a sequencing array is employed to order the frames. This sequencing array uses a frame identifier associated with the frame to perform the ordering. The operation of this sequencing array is similar to the operation of the sequencing array employed in the reassembly block 120.

In one example, the fragment re-assembly block 120 may examine the meta-data information of the received fragment and may use the link number and the class ID to look up the re-assembly context. The re-assembly block 120 may assemble the received fragments into a super-frame that can be sent via block 140 to the rest of the pipeline. In the embodiments of the present invention, the process of reassembling fragments into a super-frame involves chaining the fragments together using corresponding meta-data for the fragment. Once all the fragments for a particular super-frame are received, the super-frame is complete, as shown in box 270. The meta-data associated with the super-frame may be processed to de-multiplex a frame from the super-frame, as shown in box 280. The super-frame and/or frame may be ordered using a sequence array, as shown in box 290. The super-frame may be processed to extract individual frames, in accordance with embodiments of the present invention.

In embodiments of the present invention, the de-multiplexer 130 may output a re-assembled and de-multiplexed frame in the form of a linked list of variable sized fragments. This output may be forwarded to the rest of the pipeline, represented by block 140. For the purposes of this invention, details of the rest of the pipeline are omitted and are typically application specific. For example, the next stage may be IP forwarding if the payload data being processed by pipeline 100 is an IP frame. Alternatively, the next stage may be ATM processing if the payload data being processed by pipeline 100 is an ATM cell.

In accordance with embodiments of the present invention, new copies of payload data in the DRAM may be avoided when chaining the fragments to form the frame and/or super-frame. Minimizing the number of copies needed for processing may minimize the number of accesses to high latency DRAM that can cause performance bottlenecks.

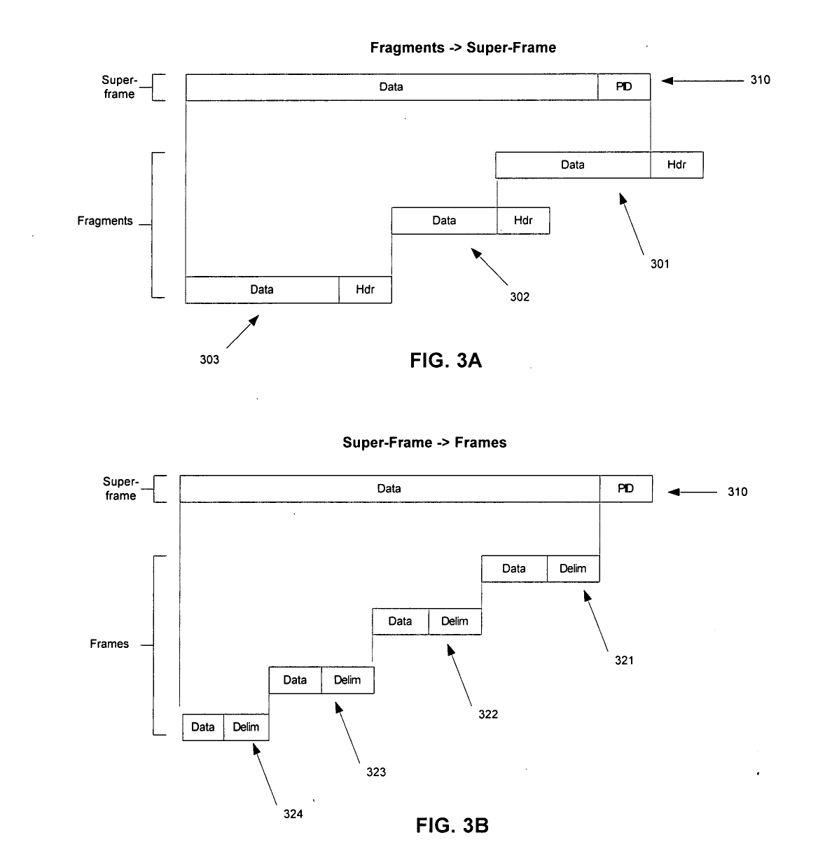

FIGS. 3A and 3B illustrate an example of the operation of the ingress pipeline 100, in accordance with an embodiment of the present invention. FIGS. 3A and 3B provide a diagrammatic representation of the relationship between fragments, frames, and super-frames. The diagrams illustrate the composition of multiple ML/MC PPP fragments into a PPP frame. The diagram also illustrates the concatenation of PPP frames into a PPP super-frame with each of the PPP frames being separated by a delimiter. In this example, fragments 301, 302, and 303 may be received on separate member links of a multi-link channel, as shown in FIG. 3A. These three fragments belong to the same super-frame 310. When reassembled, fragments 301, 302, 303 may constitute the entire super-frame 310, with fragment 301 forming the beginning of the super-frame 310, 302 forming the middle of the super-frame 310 and 303 forming the end of the super-frame 310. For the purposes of this example, the fragments are assumed to be received out of order. For example, fragment 301 may be received first, fragment 303 may be received next and fragment 302 may be received last.

In this example, the reassembled super-frame 310 may contain four (4) frames, specifically frame 321, 322, 323 and 324, as shown in FIG. 3B. FIGS. 3A and 3B illustrate the relationships between the fragments, super-frames and frames used in this example.

In accordance with embodiments of the present invention, Fragment 301 may be received by the Rx driver 110. Information in the header of fragment 301 may indicate that the fragment 301 is the beginning of a super-frame 310. The header may be stripped from the fragment 301 and the meta-data may be generated based on the stripped header data. The payload included in fragment 301 may be stored in a first memory such as DRAM 150 and the generated meta-data may be stored in a second memory such as SRAM 160. A handle to the meta-data for fragment 301 may be passed to the reassembly block 120, for example. The handle may be a pointer or the like that is associated with the meta-data. The pointer may identify the location and/or other characteristics associated with the meta-data, for example. The re-assembly block 120 may determine from the meta-data associated with fragment 301 that this is the first fragment of a super-frame and may forward the handle to the meta-data of fragment 301 to the de-multiplexing block 130. The de-multiplexing block 130 may determine that fragment 301 is the beginning of a super-frame and may strip the super-frame header from fragment 301. In embodiments of the present invention, fragment 301 may be designated as the first frame 321 within the super-frame 310.

The de-multiplexing block 130 may also strip a delimiter from the beginning of a first frame 321 within the super-frame 310. This delimiter may contain the length information about the frame and, in this example, that the length of the frame exceeds the length of fragment 301. The de-multiplexing block 130 may build meta-data for the first frame 321 in the super-frame 310 and may store this meta-data in SRAM 160.

Referring again to FIG. 3A, fragment 303 may be received by the Rx driver 110. Information in the header of fragment 303 may indicate that this fragment is the end of a super-frame. The header portion of fragment 303 may be stripped and associated meta-data may be generated based on the header. The payload data of fragment 303 may be stored in DRAM 150 and the generated meta-data may be stored in SRAM 160. A handle to the meta-data associated with fragment 303 may be passed to the reassembly block 120. The reassembly block 120 may determine from the generated meta-data associated with fragment 303 that this is the last fragment of a super-frame 310 and that this fragment is out of sequence. Fragment 303 may be placed in a sequence array, in the position determined by its sequence number.

Finally, in this example, fragment 302 may be received at the Rx driver 110. The header may be stripped and the meta-data associated with fragment 302 may be generated. The payload for fragment 302 may be stored in the DRAM 150 and the generated meta-data associated with fragment 302 may be stored in SRAM 160. A handle to the meta-data associated with fragment 302 may be passed to the reassembly block 120. The reassembly block 120 may determine from the meta-data that fragment 302 may be the next fragment in sequence for the reassembly of a particular super-frame. The reassembly block 120 may examine the sequence array and may determine that the sequence array contains the next fragment in the sequence for the super-frame, namely fragment 303.

In this example, in accordance with embodiments of the present invention, the fragment 303 may be chained to fragment 302 by setting a pointer in the meta-data associated with fragment 302 to point to the meta-data associated with fragment 303. A handle for the chain of fragments 302 and 303 (hereinafter referred to as the 302/303 chain) may be created and forwarded to the de-multiplexing block 130. The de-multiplexing block 130 may determine that 302/303 chain relates to super-frame 310.

In embodiments of the invention, the de-multiplexing block 130 may extract the remaining portion of the first frame 321 from the 302/303 chain by updating the meta-data for the frame 321 with a pointer to the payload of fragments 302 and 303. The frame 321 may be forwarded to the next stage in the ingress pipeline. The delimiter from frame 322 in the super frame 310 may be stripped and the meta-data for that frame may be generated and stored in SRAM 160, for example, and the frame 322 may be forwarded along the pipeline. This operation may continue until the end of the 302/303 chain is reached. At this point all the frames 321, 322, 323 and 324 may have been extracted from the super-frame 310 and forwarded along the ingress pipeline.

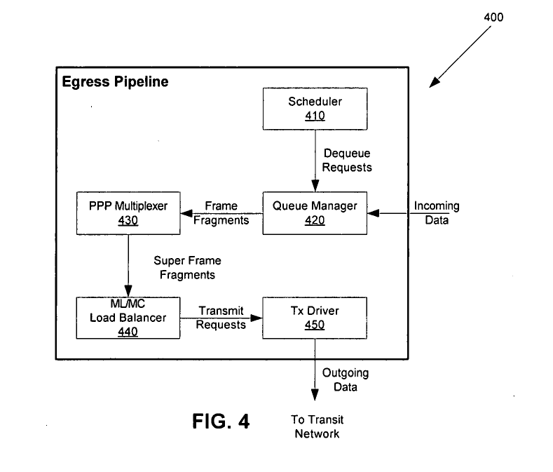

FIG. 4 is a functional block diagram illustrating an embodiment of the present invention. FIG. 4 shows a system including an egress pipeline 400 that can process data such as fragments to be transmitted over the transmission media. The illustrated egress pipeline may receive data from previous stages in a processing pipeline such as IP forwarding, ATM processing, classification blocks, etc. The outgoing data leaving the pipeline 400 may be sent to a media interface such as a multi-link transmission channel.

In embodiments of the present invention, on the egress pipeline a queue manager 420 may process incoming fragments from the previous stage in the pipeline and may be coupled to a scheduler 410 and a PPP multiplexer 430. The PPP multiplexer 430 may be coupled to a ML/MC load balancer 440 which in turn may be coupled to a transmit driver 450. The Tx driver 430 may be coupled to the media interface that provides a connection to the multi-link transmission channel, for example. The Tx driver 430 may transmit data to a transit network, as described above, via the multi-link transmission channel.

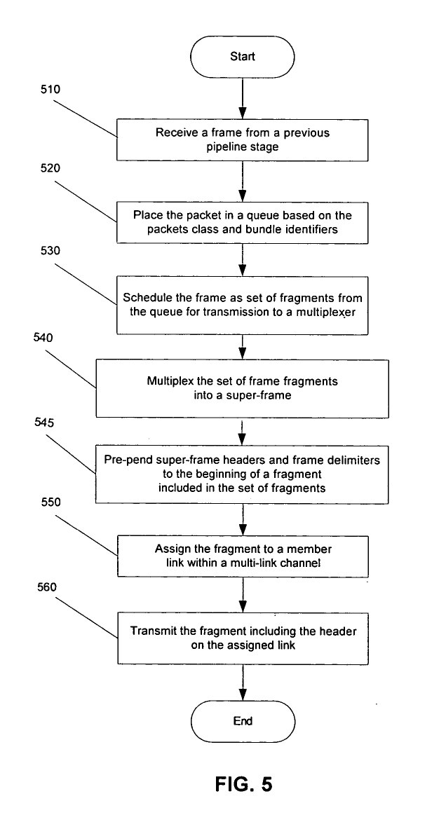

FIG. 5 is a flowchart illustrating an exemplary method in accordance with an embodiment of the present invention. As shown in box 510 of the flowchart, the queue manager 420 may receive a frame from a previous stage in the pipeline. The queue manager 420 may be a conventional queue manager that may exist in most micro-engine pipelines, for example. The queue manager 420 may perform enqueue and/or dequeue operations for the frames into and/or from the various queues it maintains. Each multi-link channel, coupled to the Tx driver 450, may have registered queues with the queue manager 420, with the number of queues registered being equal to, for example, the number of classes in the multi-link channel. The queue manager 420 may enqueue the incoming frame in an appropriate queue based on a class identifier and/or a multi-link channel identifier, as shown in box 520. The class identifier, multi-link channel identifier, and/or other information may be included in meta-data associated with the fragment. This meta-data may have been generated for the frame at a previous stage in the egress pipeline.

In embodiments of the present invention, scheduler 410 may schedule the frame as set of fragments from the queue for transmission to a multiplexer, as shown in box 530. The scheduler 410 may instruct the queue manager 420 to send a fragment included in the frame to the multiplexer 430. The scheduler 410 may be based upon the traditional schedulers used in existing micro-engine pipelines, for example. Flow control considerations may also be taken into account in the scheduling algorithm. The scheduler 410 may schedule a single fragment at a time from the frame. All the fragments may be of the same size. The scheduler 410 may send dequeue requests to the queue manager 420 to dequeue a fragment from a queued frame. The scheduler may dequeue fixed size fragments of the enqueued frames using a suitable scheduling algorithm such as weighted fair queuing (WFQ) or deficit fair queuing (DFQ). The queue manager may dequeue individual fixed size fragments from the frame and may pass the pointer to the fragment in DRAM and the meta-data of the fragment in SRAM to the PPP Mux block.

In embodiments of the invention, the scheduler 410 may treat the transmission media such as a multi-link channel as a single transmission entity so that differing channel configurations (in terms of number of member links and/or the bandwidth of each member link) may not impact data transmission. Since each multi-link channel may have a different bandwidth, the scheduler 410 may employ a weighted round robin (WRR) and/or a deficit round robin (DRR) scheduling algorithms with the weights reflecting the bandwidth of the multi-link channel. The scheduling weights may be supplied to the scheduler 410 based on the multi-link channel bandwidth.

In embodiments of the present invention, the scheduler may also provide per multi-link channel flow control by limiting the number of fragments in flight on each multi-link channel to some provisioned number. Thus, limiting the number of fragments in flight may prevent the receive queues in the downstream device from overflowing. The scheduler may read the number of fragments transmitted in each multi-link channel from the downstream load balancer and may maintain a count of the number of fragments scheduled on each multi-link channel. The transmit driver 450 may send the count of the number of fragments transmitted on the multi-link channel on a periodic basis. The transmit driver 450 and/or scheduler 410 may maintain flow control over the member link within the multi-link channel. The scheduler may subtract the number of fragments transmitted on the channel from the number of fragments scheduled in order to compute the number of fragments in flight periodically for each multi-link channel. If this number of fragments in flight is above the provisioned number, then the scheduler may assert flow control on the multi-link channel until the number of fragments in flight becomes less than the provisioned number.

In embodiments of the present invention, the multiplexer 430 may receive de-queued fragments from the queue manager 420. The multiplexer 430 may multiplex the set of frame fragments into a super-frame, as shown in box 540. The multiplexer 430 may attach appropriate header information to, for example, the first fragment of the super-frame. For example, the multiplexer may pre-pend super-frame headers and frame delimiters to the beginning of a fragment included in the set of fragments, as shown in box 545. In embodiments of the present invention, the multiplexing algorithm used by the multiplexer 430 may not need to make payload copies and may not need to employ any complicated timers such as those used in ATM Adaption Layer 2 (AAL2). ITU-T Recommendation 1.366.2, AAL Type 2 Service Specific Convergence Sublayer for Trunking ITU, Geneva, Switzerland, 1999.

As indicated above, the meta-data associated with each of these fragments will contain start of packet (SOP), end of packet (EOP) and output multi-link channel and class identifiers. If a fragment is an SOP fragment of a PPP Mux frame, a delimiter may be built for this frame and the delimiter may be pre-pended to the fragment. If the class to which this fragment belongs on the PPP multi-link channel has reached its max receive unit (MRU) bytes worth of packets at a time from any queue, if that amount of data is available, then a new PPP Mux frame may be constructed by building a PPP Mux header and pre-pending this header onto the fragment. Additional details may be provided in RFC 3153.

The PPP multiplexing state for each PPP multi-link channel and/or for each class in the multi-link channel may be maintained in terms of a running count of the number of bytes in the PPP super-frame for that combination of multi-link channel and class identifier. The rules for choosing the fragments, that should be included as frames in the mux super-frame operate within the scope of the meta-data presented to the multiplexer 430 by the queue manager 420. Once any necessary headers have been pre-pended to the fragment, the fragment may be forwarded by the multiplexer 430 to the load balancer 440. It is recognized that the process and/or method as described above may not need to create multiple copies of the fragment payload data while multiplexing. Thus, avoiding accesses to DRAM and thereby reducing the latencies and enhancing the performance.

In embodiments of the present invention, the load balancer 450 may assign the fragments to a member link within the transmission multi-link channel in a load balanced fashion, as shown in box 550. The load balancing of the fragments over the member links of the multi-link transmission channel may be based on a simple WRR scheme with the differing bandwidths of the member links being addressed by the weights of the WRR algorithm. The algorithm may also take into account flow control information and will ensure that fragments are not assigned to links that are under flow control.

Each of the data fragments may be assigned a target link number in the multi-link transmission multi-link channel by the load balancer 440 executing, for example, the WRR algorithm. A buffer descriptor including meta-information (e.g., target link number) may be included as part of the transmit request to the Tx driver 450. The transmit request may also contain additional information to create the header data. For example the additional information may include sequence identifier, class identifier, and beginning and end bits, and/or any other information that may be needed to create the header information for the frames.

The Tx driver 450 may receive transmit requests from the load balancer 440 and may transmit the requested data over the specified link. The buffer descriptor may be sent to the Tx driver 450 for transmitting each fragment on the various links of the transmission multi-link channel, as shown in box 560. The Tx driver block 450 may then build and transmit the ML/MC header prior to transmitting the fragment data.

In embodiments of the present invention, flow control information may be used to control the member links within the multi-link transmission channel. The incorporation of flow control information into the scheduling algorithm may be used to prevent the fragments from being scheduled for a member link of the multi-link channel that are under flow control. Statistics relating to the number of fragments transmitted on each multi-link channel may be passed from the Tx driver 450 to the scheduler 410 at regular intervals.

In embodiments of the present invention, the buffer used for transmitting the fragments over the transmission interface may be freed by the Tx driver 430, after all the fragments for a given buffer have been transmitted. It is recognized that any conventional technique may be used to transmit data over the transmission interface. It is recognized that the data pointed to by the transmit request may span multiple chained buffers and so the Tx driver may handle this buffer chaining when copying the data from the buffer chain for transmission over the media interface.

In embodiments of the present invention, the functionality of the ingress and/or egress pipeline described above may be implemented using a processor that may be a parallel multi-threaded network processor or other type of processor. The processor may include multiple micro-engines or processing engines each with multiple hardware controlled threads that may be simultaneously active and/or independently work on a specific task. In such an implementation, one may need to make sure that different threads working on a specific task access and/or update the shared data structures in a consistent manner. Also in a multi-threaded, multiprocessor implementation, one may need to make sure that the individual fragments being processed by individual threads do not get reordered. The multi-threaded, multi processor implementation, as described herein, may be included in a terminal such as a communications terminal, a computer, or the like.

In embodiments of the present invention, when using a multithreaded, multiprocessor system like a network processor, the impelementation may be made scalable with the number of multi-link channels supported, number of member links in each multi-link channel and their bandwidths by allocating the right number of threads and processors for each function.

It is recognized that embodiments of the present invention as described herein may be applied using a software program that may be generated by one of ordinary skill in the art based on the details provided herein. It is recognized that the software program may be implemented in a modular fashion such that the software can be reused in other applications requiring multi-link channel transmission. Such a software program may be implemented in a multi-processor and multi-threaded environment without fragments being re-ordered or data accesses being inconsistent. Embodiments of the present invention as described herein may be scalable in terms of the number of ports, member links and multi-link channels in the system. Moreover, the invention may be scalable in terms of the number of member links within a multi-link channel as well as in terms of the data rates of the member-links within the system.

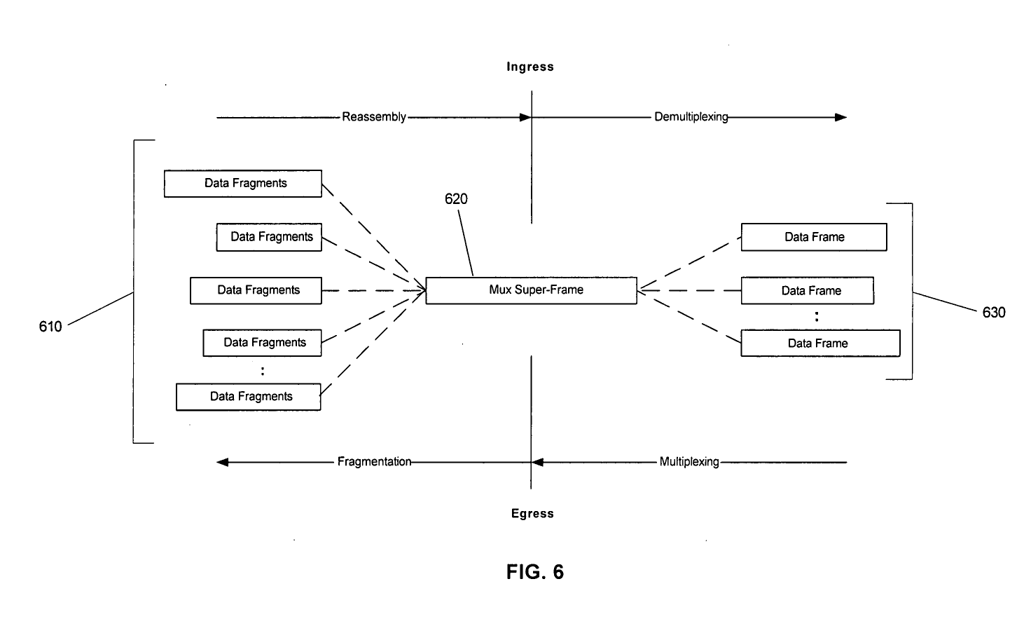

FIG. 6 is a block diagram illustrating functional aspects of the ingress and egress pipelines in accordance with embodiments of the present invention. On the ingress side, a plurality of data fragments 610 may be received and re-assembled into a mux super-frame 620 and the mux super-frame 620 may be de-multiplexed into a plurality of data frames 630 as described above, for example. On the egress side, the plurality of data frames 630 may be multi-plexed into a mux super-frame 620 and then fragmented into a plurality data fragments 610 as described above, for example.

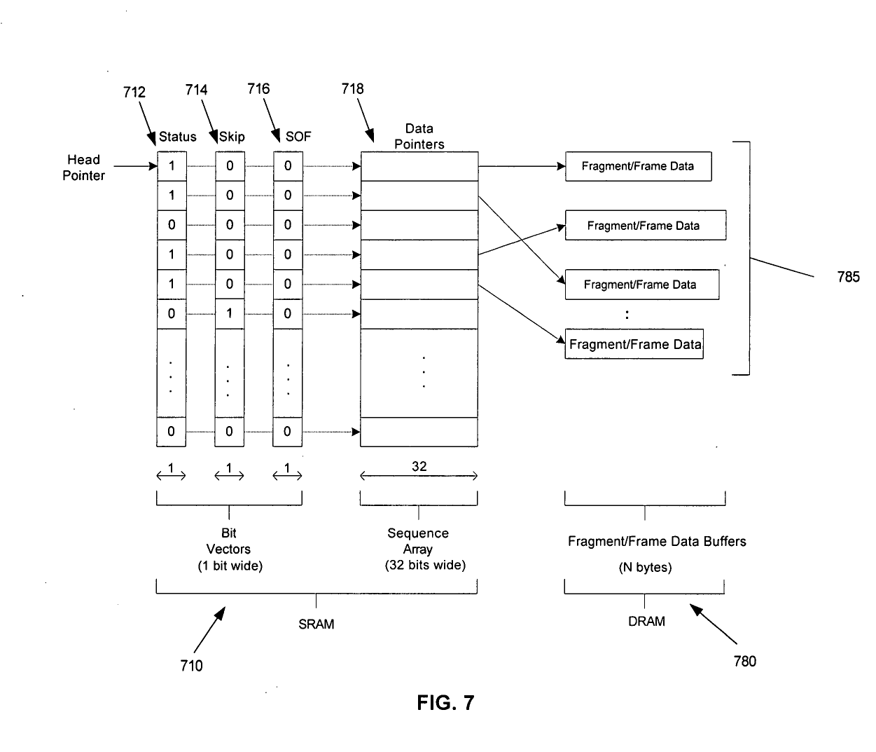

FIG. 7 is a diagrammatic representation of a sequence array in accordance with embodiments of the present invention. A low latency memory such as an SRAM may contain administrative or header data 410. The higher latency memory such as a DRAM may store payload data 780. The administrative data may contain a plurality of bit vectors that may include, for example, status bits 712, skip bits 714 and start of frame (SOF) bit 716. If the status bit 712 is set (e.g., status bit=1), this may indicate that the corresponding data is active. If the status bit 712 is not set (e.g., status bit=0), this may indicate that the corresponding data may not be active. The skip bits 714 may indicate whether the corresponding data should be skipped. The SOF bits 716 may indicate whether the corresponding data is a start of the frame. If the SOF bit 716 is set (i.e., SOF bit=1), this may indicate that the corresponding data is the start of the frame.

In embodiments of the present invention, the administrative data 710 may also include a sequence array that includes data pointers 718. The data pointers may point to the location in the memory such as a DRAM where corresponding payload information such as fragment and/or frame data 785 may be stored. The sequence array may be accessed to assemble the data frames or generate data fragments based on processed meta-data.

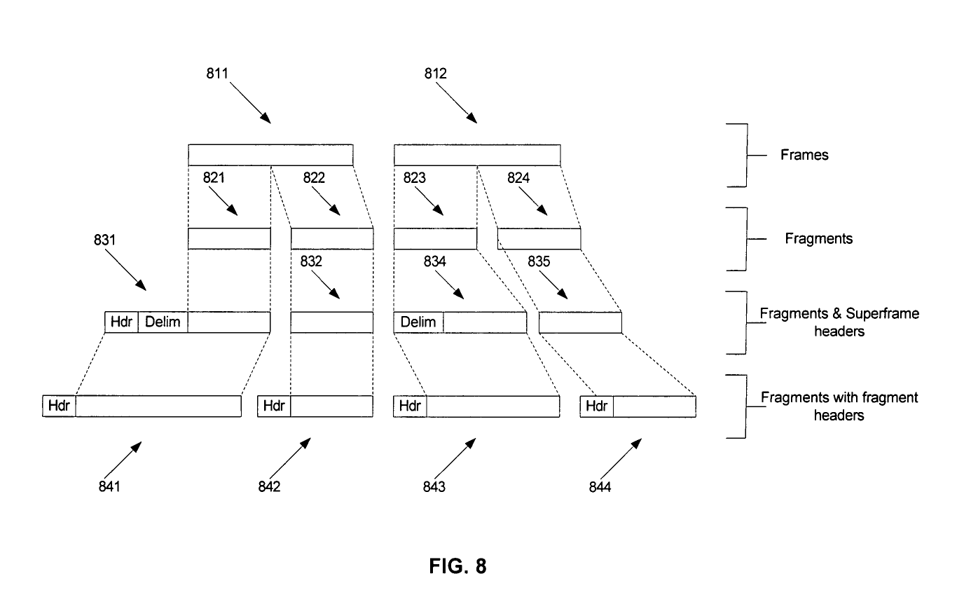

FIG. 8 illustrates an example of the operation of the egress pipeline 400, in accordance with an embodiment of the present invention. FIG. 8 provides a diagrammatic representation of the fragmentation of frames into fragments and the attachment of super-frame headers, delimiters and fragment headers, in accordance with an embodiment of the present invention. Frames 811 and 812 may be received from an earlier stage in the pipeline and may be enqueued by the queue manager 420.

For the purposes of this example, both frames 811 and 812 have the same class ID and multi-link channel ID in their associated meta-data. The scheduler 410 may issue a dequeue request to the queue manager 420 to dequeue fragment 821 from frame 811. The fragment 821 may be passed to the multiplexer 430. The multiplexer 430 may determine that fragment 821 is at the beginning of a frame by examining the SOF indicator that may be included in the fragment's meta-data. The multiplexer 430 may pre-pend a super-frame delimiter to the start of fragment 821. The multiplexer 430 may also determine that a new super-frame should be constructed and may pre-pend a super-frame header to the start of fragment 821 to form fragment 831.

The fragment 831 may be passed to the load balancer 440 that may assign the fragment to a member link and forward the fragment to the Tx driver 450 for transmission. The Tx driver 450 may pre-pend a fragment header to fragment 831 to form fragment 841, as shown in FIG. 8. Fragment 841 may then be transmitted over the assigned member link in the multi-link channel.

To continue with the above example, the scheduler 410 may issue a dequeue request to the queue manager 420 to dequeue fragment 822 from frame 811. This fragment may be passed to the multiplexer 430. The multiplexer 430 may determine that fragment 822 is not at the beginning of a frame by examining the SOF indicator that may be included in the fragment's meta-data. The multiplexer 430 may forward fragment 822 (which in this case may be the same as fragment 832) to the load balancer 440 which may assign the fragment to a member link and forward the fragment to the Tx driver 450 for transmission. The Tx driver 450 may pre-pend a fragment header to fragment 832 to form fragment 842. Fragment 842 may then be transmitted over the assigned member link in the multi-link channel.

Referring again to FIG. 8, the scheduler 410 may issue a dequeue request to the queue manager 420 to dequeue fragment 823 from frame 812. This fragment may be passed to the multiplexer 430. The multiplexer 430 may determine that fragment 823 is at the beginning of a frame by examining the SOF indicator that may be included in the fragment's meta-data. The multiplexer 430 may pre-pend a super-frame delimiter to the start of fragment 823 to form fragment 833. The multiplexer 430 may forward fragment 833 to the load balancer 440 which may assign the fragment to a member link and may forward the fragment to the Tx driver 450 for transmission. The Tx driver 450 may pre-pend a fragment header to fragment 833 to form fragment 843. Fragment 843 may then be transmitted over the assigned member link in the multi-link channel.

With respect to fragment 824 included in frame 812, the scheduler 410 may issue a dequeue request to the queue manager 420 to dequeue fragment 824 from frame 812. This fragment may be passed to the multiplexer 430. The multiplexer 430 may determine that fragment 824 is not at the beginning of a frame by examining the SOF indicator that may be included in the fragment's meta-data. The multiplexer 430 may forward fragment 824 (which in this case may be the same as fragment 835) to the load balancer 440 which may assign the fragment to a member link and forward the fragment to the Tx driver 450 for transmission. The Tx driver 450 may pre-pend a fragment header to fragment 835 to form fragment 844. Fragment 844 may then be transmitted over the assigned member link in the multi-link channel.

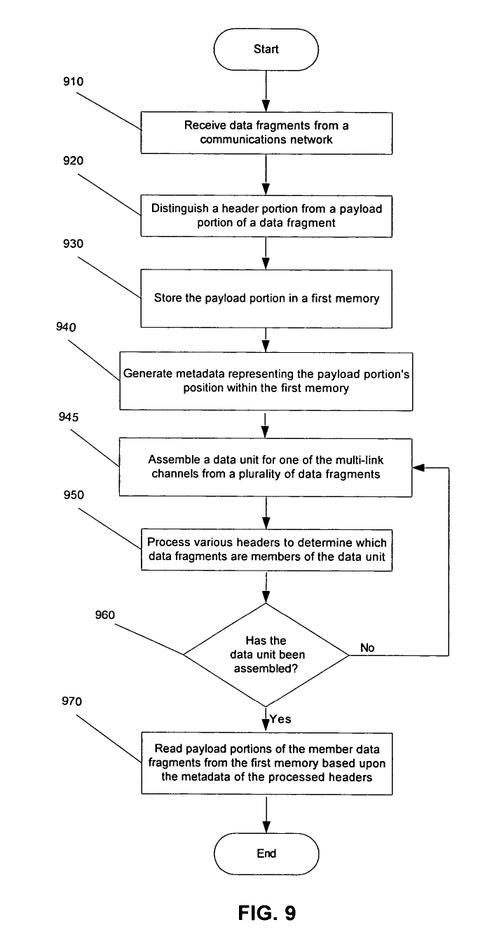

FIG. 9 is a flowchart illustrating an exemplary method in accordance with an embodiment of the present invention. As shown in box 910 of the flowchart, data fragments may be received from a communications network. Each data fragment may be a member of one of a plurality of active multi-link channels. A header portion may be distinguished from a payload portion of a data fragment, as shown in box 920. The payload portion may be stored in a first memory, as shown in box 930. As shown in box 940, meta-data representing the payload portion's position within the first memory may be generated. A data unit for one of the multi-link channels may be assembled from a plurality of data fragments, as shown in box 945. In embodiments of the present invention, the assembly of the data unit may include the processing of various headers to determine which data fragments are members of the data unit, as shown in box 950. If the data unit has been assembled, the payload portions of the member data fragments may be read from the first memory based upon the meta-data of the processed headers, as shown in boxes 960 and 970. If the data unit has not been assembled, continue to assemble the data unit for one of the multi-link channels from a plurality of data fragments, as shown in boxes 960 and 945.

Embodiments of the present invention provide a method and apparatus for processing communications data. Embodiments of the present invention may reduce performance bottlenecks introduced when data fragments are copied from one location in a DRAM, for example, to another location for processing. Such processing may include, for example, multi-plexing, de-multiplexing, re-assembly, fragmentation, etc. Since DRAM accesses have long access latency, embodiments of the present invention may improve processing performance by minimizing the number of copies of data that may be needed during processing. Minimizing the number of copies needed for processing may minimize the number of accesses to high latency DRAM that can cause performance bottlenecks.

Several embodiments of the present invention are specifically illustrated and/or described herein. However, it will be appreciated that modifications and variations of the present invention are covered by the above teachings and within the purview of the appended claims without departing from the spirit and intended scope of the invention.

1. Apparatus comprising:
a receive interface to couple to a multi-link communications channel;
a processing system to process header portions of data fragments received from the multi-link communications channel and a separate processing system to process payload portions of the data fragments from the multi-link communications channel, wherein the payload processing system includes a memory that is slower than a memory of the header processing system.

2. The apparatus of claim 1, the header processing system comprising:
a fragment re-assembler to re-assemble the header portions of the data fragments into a super frame based on the payload portions of the data fragments stored in the higher latency memory.

3. The apparatus of claim 2, the header processing system comprising:
a de-multiplexer to de-multiplex the super frame using the header portions of the data into a frame.

4. A data processing system, comprising:
a receive interface to receive data fragments from a communications network, each data fragment being a member of one of a plurality of active multi-link channels and wherein the receive interface is to distinguish a header portion from a payload portion of a data fragment;
a memory to store the payload portion of the data fragment, wherein the receive interface is to generate meta-data representing the payload portion's position within the memory;
a communications bus; and
a processor coupled to the receive interface and the first memory via the communications bus, the processor is to assign data fragments to a data unit for one of the multi-link channels based on the header portion of the data fragments, and only after the fragments are assigned, to read payload portions of the member data fragments from the memory based on the meta-data of the processed headers to assemble the data unit.

5. The data processing system of claim 4, wherein the processor is to process the meta-data using a sequence array to assemble the data unit.

6. The data processing system of claim 4, further comprising:
a second memory to store the meta-data, wherein the memory to store the meta-data is faster than the memory to store the payload portion of the data fragment.

7. A data processing method, comprising:
receiving data fragments from a communications network, each data fragment being a member of one of a plurality of active multi-link channels,
distinguishing a header portion from a payload portion of a data fragment,
storing the payload portion in a first memory,
generating meta-data representing the payload portion's position within the first memory,
assembling a data unit for one of the multi-link channels from a plurality of data fragments, the assembling including:
processing various headers to determine which data fragments are members of the data unit, and
only after the data unit is assembled, reading payload portions of the member data fragments from the first memory based upon the meta-data of the processed headers.

8. The data processing method of claim 7, wherein no other read of the member payload portions occur before the data unit is assembled.

9. The data processing method of claim 7, the method further comprising:
storing the generated meta-data in a second memory which is faster than the first memory.

10. A method comprising:
receiving data fragments on a member link of a multi-link channel;
stripping header data from payload data of the data fragments;
generating meta-data based on the header data of the received fragments;
storing the payload data in a first memory and storing the meta-data in a second memory, wherein the meta-data includes an identifier of a position of the corresponding payload data in the first memory;
processing the meta-data using a sequence array and buffer chaining to reassemble fragments into a super-frame;
processing the meta-data associated with the super-frame to de-multiplex a frame from within the super-frame; and
ordering the re-assembled super-frame and the de-multiplexed frame using the sequence array.

11. The method of claim 10, further comprising:
determining if the data fragment belongs to the super-frame;
determining if the data fragment belonging to the super-frame is in order; and
if the data fragment belongs to the super-frame and is in order, forwarding the data fragment to a de-multiplexer.

12. The method of claim 10, further comprising:
assigning a position for the fragment in the sequencing array based on a sequence number associated with the fragment, wherein the fragment is stored in the relative order of its sequence numbers.

13. The method of claim 10, further comprising:
reassembling the fragments into the super-frame without creating multiple copies of the payload data stored in the first memory.

14. The method of claim 10, wherein the meta-data includes at least one of a start of packet indicator, end of packet indicator, sequence number, class identifier, member link identifier, multi-link channel identifier, fragment length, frame length, pointer identifying the associated payload data in the first memory, and a pointer to the meta-data of a next fragment in a chain.

15. A method comprising:
receiving a data frame from a previous frame in a pipeline;
enqueing the received frame in an appropriate queue based on a class identifier and a multi-link channel identifier associated with the frame;
scheduling the frame as set of fragments from the queue for transmission to a multiplexer;
multiplexing the set of fragments into a super-frame;
pre-pending super-frame headers and frame delimiters to the beginning of a fragment included in the set of fragments;
assigning the fragment to a member link within a multi-link channel in a load balanced manner by balancing the load on the member link of the multi-link channel; and
transmitting the fragment including the header over the assigned member link of the multi-link channel.

16. The method of claim 15, further comprising:
dequeuing the set of fragments of the enqueued frame using a cell dequeue algorithm, wherein the cell dequeue algorithm includes dividing the frame into multiple fixed size fragments and dequeuing a same frame pointer as many number of times from the queue as a number of fragments in the frame.

17. The method of claim 16, wherein dequeuing the set of fragments of the enqueued frame without creating multiple copies of the payload data stored in a first memory.

18. The method of claim 15, wherein multiplexing the set of fragments into the super-frame without creating multiple copies of the payload data stored in a first memory.

19. The method of claim 15, further comprising:
balancing the load in the member link of the multi-link channel using at least one of a weighted fair queuing algorithm and a deficit fair queuing algorithm.

20. Apparatus comprising:
a receive interface to receive data fragments on a member link of a multi-link channel, to strip the header data from the payload data included in the data fragments, and to generate meta-data based on the header data of the received fragments;
a first memory to store payload data;
a second memory to store the generated meta-data, wherein the meta-data includes an identifier of a position of the corresponding payload data stored in the first memory;
a fragment re-assembler to process the meta-data using a sequence array and buffer chaining to reassemble fragments into a super-frame; and
a de-multiplexer to process the meta-data associated with the super-frame to de-multiplex a frame from within the super-frame, and the de-multiplexer to order the re-assembled super-frame and the de-multiplexed frame using the sequence array.

21. The apparatus of claim 20, wherein the fragment re-assembler is to further determine if the data fragment belongs to the super-frame and if the fragment is in order and if the data fragment belongs to the super-frame and is in order, the fragment re-assembler is to forward the data fragment to the de-multiplexer.

22. The apparatus of claim 20, wherein the fragment re-assembler is to further reassemble the fragments into the super-frame without creating multiple copies of the payload data stored in the first memory.

23. Apparatus comprising:
a queue manager to enqueue a received frame in an appropriate queue based on a class identifier and a multi-link channel identifier associated with the frame;
a scheduler to schedule the frame as set of fragments from the queue;
a multiplexer to receive the set of fragments and to multiplex the set of fragments into a super-frame, wherein the multiplexer is to pre-pend super-frame headers and frame delimiters to the beginning of a fragment included in the set of fragments;
a load balancer to assign the fragment to a member link within a multi-link channel in a load balanced manner by balancing the load on the member link of the multi-link channel; and
a transmit interface to transmit the fragment including the header over the assigned member link of the multi-link channel.

24. The apparatus of claim 23, wherein the multiplexer is to multiplex the set of fragments into the super-frame without creating multiple copies of the payload data.

25. A system comprising:
a multi-link transmission channel including a plurality of member channels coupled to a transit network;
a terminal coupled to a member link included in the plurality of member links, wherein the terminal includes a multi-threaded processor having an ingress pipeline to receive data fragments on the member link of the multi-link channel, to strip the header data from payload data included in the data fragments, to generate meta-data based on the header data of the received fragments and to process the meta-data using a sequence array and buffer chaining to reassemble fragments into a super-frame,
a first memory to store the payload data; and
a second memory to store the generated meta-data, wherein the meta-data includes an identifier of a position of the corresponding payload data stored in the first memory.

26. The system of claim 25, wherein the terminal includes a plurality of multi-threaded processors.

27. A system comprising:
a multi-link transmission channel including a plurality of member links coupled to a transit network; and
a terminal coupled to a member link included in the plurality of member links, wherein the terminal includes a multi-threaded processor having an egress pipeline to enqueue a received frame in an appropriate queue based on a class identifier and a multi-link channel identifier associated with the frame, to multiplex a set of fragments into a super-frame, and to pre-pend super-frame headers and frame delimiters to the beginning of a fragment included in the set of fragments.

28. The system of claim 27, wherein the egress pipeline comprising:
a scheduler to schedule the frame as set of fragments from the queue; and
a load balancer to assign the fragment to the member link within the multi-link channel in a load balanced manner by balancing the load on the member link of the multi-link channel.

29. The system of claim 27, wherein the terminal includes a plurality of multi-threaded processors.
